(19) United States
(12) Patent Application Publication
(10) Pub. No.: US 2016/0084666 A1
(43) Pub. Date: Mar. 24, 2016

(54) ROUTING ENGINE

(71) Applicant: TOMTOM DEVELOPMENT GERMANY GMBH, Leipzig (DE)

(72) Inventors: Tetyana Dzyuba, Berlin (DE); Jan-Ole Sasse, Berlin (DE)

(21) Appl. No.: 14/785,363

(22) PCT Filed: Apr. 17, 2014
(86) PCT No.: PCT/EP2014/057989

§ 371 Date: Oct. 19, 2015

Related U.S. Application Data
(60) Provisional application No. 61/813,162, filed on Apr. 17, 2013.

(51) Int. Cl. G01C 21/34; G08G 1/0968

(52) U.S. Cl. CPC G01C 21/3492; G08G 1/096827; G08G 1/096844

(57) ABSTRACT

A route planning system comprising a routing engine is described in which data access to map data for selecting from a plurality of routes comprises means for receiving traffic data for a plurality of routes between two nodes and using the traffic data with map data to select an initial best route between the two nodes.

### FIELD OF THE INVENTION

This invention relates to a routing engine and route planning and navigation systems and method comprising the routing engine. Illustrative embodiments of the invention relate to portable navigation devices (so-called PNDs), in particular PNDs that include Global Positioning System (GPS) signal reception and processing functionality. Other embodiments relate, more generally, to any type of route planning device that is configured to execute routing software so as to provide route planning, and preferably also navigation, functionality, such as, for example, a server-based route planning system.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to provide an additional input interface by means of which a user can operate the device by touch.

Devices of this type often also include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above provide a reliable means for enabling users to navigate from one position to another.

In known routing engines, as illustrated in FIG. 4, a route is initially determined 601 using the base map data without taking into account “live” data, such as traffic. Then a check is made 602 of “live” data, e.g. traffic delays, to determine 603 whether a delay exists on route segments forming part of the calculated route. If so, then the route has to be recalculated taking into account the current traffic conditions before the selected route is displayed 604.

The present invention provides an improved routing engine and method for route planning and navigation systems.

### SUMMARY OF THE INVENTION

According to a first aspect of the invention there is provided a route planning system comprising a routing engine in which data access to mapping data for selecting from a plurality of routes comprises means for receiving traffic data for a plurality of routes between two nodes and using the traffic data with map data to select an initial best route between the two nodes.

Conveniently, the route planning system comprises means for the determination of a traffic delay on any of the plurality of routes and the expected duration of the traffic delay and using the location and expected duration of the traffic delay in selecting the best route.

Conveniently, the means for determining an expected duration of the traffic delay comprises means for analysing live probe traffic data.

Conveniently, the route planning system comprises means for determining an average speed variation during the expected duration of the traffic delay.

Conveniently, the route planning system comprises means for calculating a routing penalty for a segment of a route that enters a point on a route within a traffic jam to allow a preferred route to be generated that will completely avoid the traffic jam if possible.

Conveniently, the route planning system comprises means for obtaining real-time traffic data from any of a plurality of sources, using this data to determine a current average speed of travel on segments of a route, comparing the average speed of travel with stored historic speed profiles created from traffic probe data that give the average speed of travel on each segment of a digital map at different times of a day and preferably different days of the week and identifying a traffic event when the current speed drops below the historic speed by a more than a predetermined threshold and generating an associated traffic message including an indication of the current average speed.

Conveniently, all traffic messages for a first area around the current position of a vehicle are received by the route planning system, but only significant traffic messages, based on distance to the incident, severity of the incident, expected delay, for a second larger area are received by the route planning system.

Conveniently, the route planning system comprises means for determining a traffic jam tendency parameter indicating whether a jam is growing or shrinking and/or a predicted expiration time.

Conveniently, the route planning system comprises means for providing visual information to a user of the traffic jam tendency parameter.

Conveniently, the route planning system comprises means for using the predicted expiration time and location to decide which traffic jams are to be used by the routing engine.

According to another aspect of the invention, there is provided a method of planning a route using a routing engine in which data access to mapping data for selecting from a plurality of routes comprising receiving traffic data for a plurality of routes between two nodes and using the traffic data with map data to select a best initial route between the two nodes.

Conveniently, the method comprises determining a traffic delay on any of the plurality of routes and the expected duration of the traffic delay and using the location and expected duration of the traffic delay in selecting the best route.

Conveniently, the method comprises determining an expected duration of a traffic delay by analysing live probe traffic data.

Conveniently, the method comprises determining an average speed variation during the expected duration of the traffic delay.

Conveniently, the method comprises calculating a routing penalty for a segment of a route that enters a point on a route within a traffic jam to allow a preferred route to be generated that will completely avoid the traffic jam if possible.

Conveniently, the method comprises obtaining real-time traffic data from any of a plurality of sources, using this traffic data to determine a current average speed of travel on segments of a route, comparing the average speed of travel with stored historic speed profiles created from traffic probe data that give the average speed of travel on each segment of a digital map at different times of a day and preferably different days of the week and identifying a traffic event when the current speed drops below the historic speed by a more than a predetermined threshold and generating an associated traffic message including an indication of the current average speed.

Conveniently, the method comprises all traffic messages for a first area around the current position of a vehicle being received by the route planning system, but only significant traffic messages, based on distance to the incident, severity of the incident, expected delay, for a second larger area being received by the route planning system.

Conveniently, the method comprises determining a traffic jam tendency parameter indicating whether a jam is growing or shrinking and/or a predicted expiration time.

Conveniently, the method comprises providing visual information to a user of the traffic jam tendency parameter.

Conveniently, the method comprises using the predicted expiration time and location to decide which traffic jams are to be used by the routing engine.

According to another aspect of the invention, there is provided computer software operable, when executed on a system as described above, to cause one or more processors to plan a route using a routing engine wherein data access to mapping data for selecting from a plurality of routes comprises receiving traffic data for a plurality of routes between two nodes and using the traffic data with map data to select a best initial route between the two nodes.

### BRIEF DESCRIPTION OF THE DRAWINGS

Various embodiments of the present invention will now be described with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIG. 4 is a flowchart of a known method of selecting a route;

FIG. 5 is a flowchart of a method of selecting a route according to the invention;

FIG. 6 is a flowchart of a further method of selecting a best route according to the invention;

FIG. 7 is a flowchart of a method of using an expected duration of a traffic delay in an embodiment of the invention; and

FIG. 8 is a flowchart of a method of using a route penalty in an embodiment of the invention.

### DETAILED DESCRIPTION OF PREFERRED EMBODIMENTS

Preferred embodiments of the present invention will now be described. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or a mobile telephone or portable digital assistant (PDA)) executing route planning and navigation software.

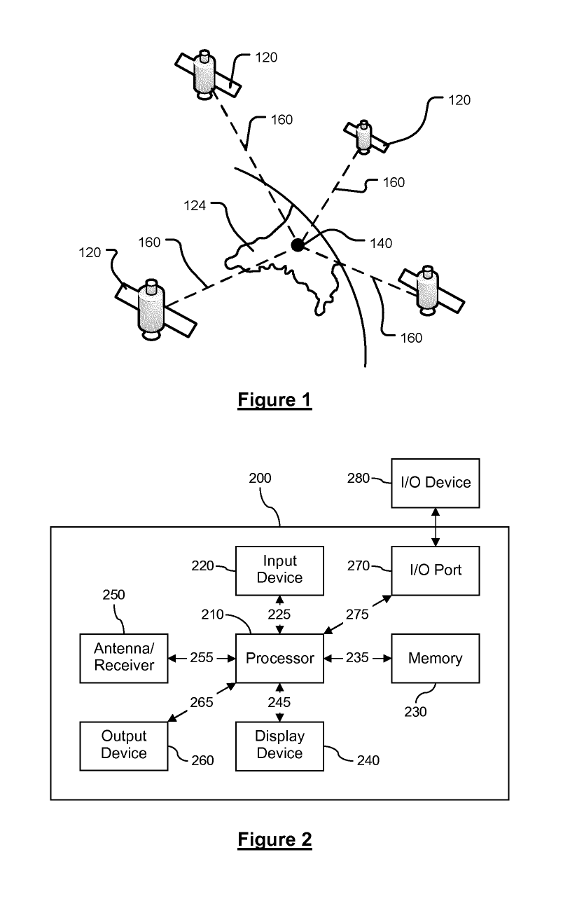

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, a plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the

GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 220 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, 265 respectively to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

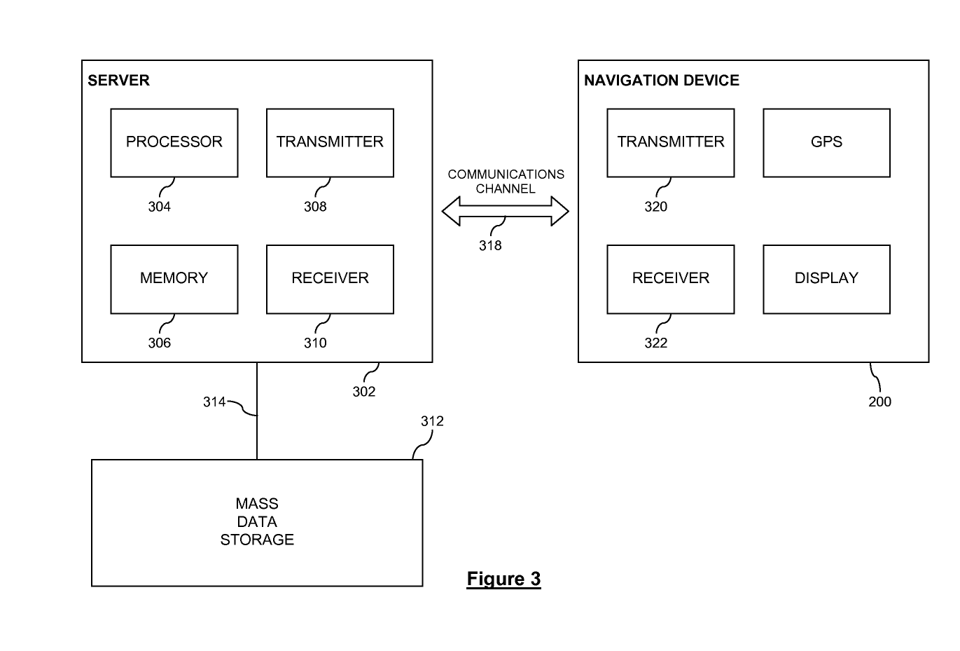

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

The architecture of the new routing engine is configured to calculate routes with “live” data if it is known. This is clearly more efficient, and also allows alternate routes to be determined with “live” data, which was not possible with the prior art.

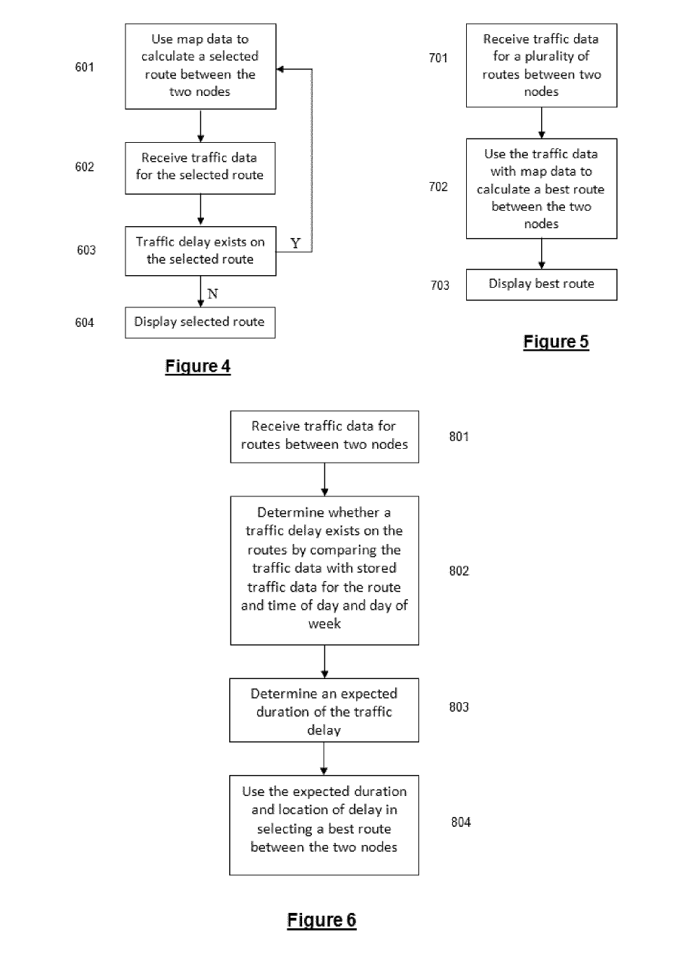

Referring to FIG. 5, in a method according to the invention of calculating an initial route between two nodes, traffic data is received 701 for a plurality of routes between the two nodes. The traffic data is then used with map data to calculate 702 a best route between the two nodes and the best route is displayed 703. It will be understood that one method of using the traffic data with the map data is to update the map data with the traffic data.

Referring to FIG. 6, the routing engine is also configured to support traffic duration information that is provided in a traffic service. The traffic duration information provides an indication as to when a traffic delay is expected to expire. Traffic data is received 801 for routes between two nodes. It is then determined 802 whether a traffic delay exists on the routes by comparing the traffic data with stored traffic data for the corresponding time of day on the corresponding day of the week. The expected duration of the delay may also be determined 803 by analysis of live traffic probe data. The location of the traffic delay and the expected expiry time of the traffic delay can then be taken into account in selecting 804 a best route between the two nodes.

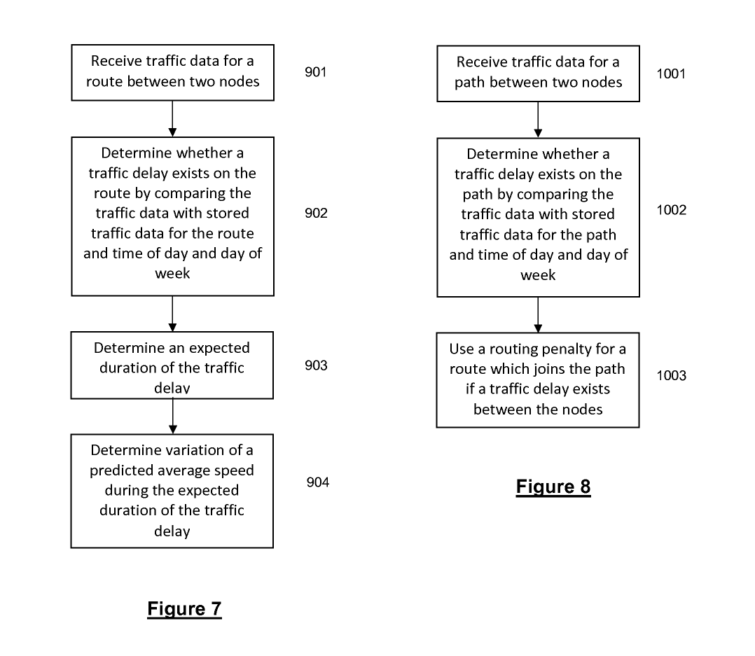

The traffic duration information can also include a prediction how the average speed will vary during the predicted lifetime of the jam. Due to the time-dependent routing that is possible with the routing engine of the invention; this traffic duration information can be taken into account. The traffic duration information is determined from analysing live probe data, and has not been used in a routing engine in the prior art. Referring to FIG. 7, traffic data is received 901 for a route between two nodes. As previously described, it is determined 902 whether a traffic delay exists between the two nodes and an expected duration of the traffic delay determined 903. This information can then be used to determine 904 a variation in the average speed between the two nodes taking into account the expected duration of the traffic delay.

This may be contrasted with the prior art, in which each traffic jam on the same size of road was treated as expiring after the same period of time as set within the routing engine.

Another aspect of the routing engine, which is again supported by the improved use of live information, is that a routing penalty is utilised for a segment that enters the middle of a traffic jam. This allows a better route to be generated that will completely avoid a jam, unless absolutely required. Referring to FIG. 8, traffic data is received for a path between two nodes and, as before, it is determined 1002 whether a traffic delay exists between the two paths. If a traffic delay exists, a routing penalty is then imposed 1003 for any route segment which joins the path between the nodes.

The same routing engine can be utilised on a mobile device or on a server; the main difference being that the server will be aware of all traffic information, whereas the device is aware only of traffic around its current position due to the way in which the traffic system works.

The traffic system works as follows: essentially, historic speed profiles (created from probe data) are stored that give the average speed of travel on each segment of a digital map at all times of the day, in 5-minute intervals, for each day of the week. Real-time data is obtained from a number of sources, including GPS probe data, GSM probe data and journalistic data, and this data is used to determine a current average speed of travel on segments of a route. If a traffic event is identified (i.e. the current speed drops below a historic speed by a more than a predetermined threshold), then an associated traffic message is generated including an indication of the current average speed. In order to manage bandwidth consumption, all traffic messages for an inner circle/square area around the current position of a vehicle are delivered to devices, but only important traffic messages (based on distance to the incident, severity of the incident, expected delay, etc) for a larger outer circle/square area. The traffic messages may additionally include a traffic jam tendency parameter (whether a traffic jam is growing or shrinking) and/or a predicted expiration time. The tendency can be used to provide visual information to the user, and the predicted expiration time can be used to decide which traffic jams to include in the routing engine.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device may utilise any kind of position sensing technology as an alternative to (or indeed in addition to) GPS. For example, the navigation device may utilise other global navigation satellite systems, such as the European Galileo system. Equally, it is not limited to satellite-based systems, but could readily function using ground-based beacons or other kind of system that enables the device to determine its geographic location.

It will also be well understood by persons of ordinary skill in the art that whilst the described embodiments implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A computer implemented method of planning a time-dependent route between a first location and a second location using a routing engine, wherein the routing engine has access to map data comprising a plurality of segments, the method comprising:
receiving traffic data indicative of one or more traffic delays, each traffic delay being associated with: location information indicating a location of the respective traffic delay; and duration information indicative of when the respective traffic delay is expected to expire; and,
when planning the time-dependent route, imposing a routing penalty for any segment that enters a point within a traffic delay, so as to generate a route that preferentially avoids the traffic delay.

2. The method of claim 1, wherein the presence of a traffic delay is determined using the duration information and location information.

3. The method of claim 1, wherein the duration information for each traffic delay is determined by analysing live probe traffic data.

4. A time-dependent route planning system configured to plan a time-dependent route between a first location and a second location using a routing engine, wherein the routing engine has access to map data comprising a plurality of segments, the system comprising one or more processors arranged to:
receive traffic data indicative of one or more traffic delays, each traffic delay being associated with: location information indicating a location of the respective traffic delay; and duration information indicative of when the respective traffic delay is expected to expire; and,
when planning the time-dependent route, impose a routing penalty for any segment that enters a point within a traffic delay, so as to generate a route that preferentially avoids the traffic delay.

5. The system of claim 4, wherein the presence of a traffic delay is determined using the duration information and location information.

6. The system of claim 4, wherein the duration information for each traffic delay is determined by analysing live probe traffic data.

7. A non-transitory computer readable medium comprising computer software operable, when executed on a route planning system comprising one or more processors, to cause the one or more processors to perform a method according to claim 1.

8. (canceled)

9. A computer implemented method of planning a time-dependent route between a first location and a second location using a routing engine, wherein the routing engine has access to map data comprising a plurality of segments, the method comprising:
receiving traffic data indicative of one or more traffic delays, each traffic delay being associated with: location information indicating a location of the respective traffic delay; and duration information indicative of when the respective traffic delay is expected to expire;
planning a plurality of time-dependent routes between the first location and the second location, wherein said planning comprises imposing a routing penalty for any segment of a route that enters a point within a traffic delay determined to exist on other segments using the duration information and location information for the respective traffic delay, so as to preferentially avoid the traffic delay;
selecting one of the plurality of routes as the optimum route between the first location and the second location time-dependent route; and
generating navigation instructions to guide a user along the selected optimum route.
